(19) United States
(12) Patent Application Publication
(10) Pub. No.: US 2015/0302317 A1
(43) Pub. Date: Oct. 22, 2015

(54) NON-GREEDY MACHINE LEARNING FOR HIGH ACCURACY

(71) Applicant: Microsoft Corporation, Redmond, WA (US)

(72) Inventors: Mohammad Norouzi, Toronto (CA); Pushmeet Kohli, Cambridge (GB)

(73) Assignee: Microsoft Corporation, Redmond, WA (US)

(21) Appl. No.: 14/259,117

(22) Filed: Apr. 22, 2014

(51) Int. Cl. G06N 99/00

(52) U.S. Cl. CPC G06N 99/005

(57) ABSTRACT

Non-greedy machine learning for high accuracy is described, for example, where one or more random decision trees are trained for gesture recognition in order to control a computing-based device. In various examples, a random decision tree or directed acyclic graph (DAG) is grown using a greedy process and is then post-processed to recalculate, in a non-greedy process, leaf node parameters and split function parameters of internal nodes of the graph. In various examples the very large number of options to be assessed by the non-greedy process is reduced by using a constrained objective function. In examples the constrained objective function takes into account a binary code denoting decisions at split nodes of the tree or DAG. In examples, resulting trained decision trees are more compact and have improved generalization and accuracy.

### BACKGROUND

Machine learning technology comprising trained random decision trees and forests, and/or trained directed acyclic graphs (DAGs) is increasingly used in a variety of situations. For example, in gesture recognition systems, object recognition systems, robotics, medical image analysis, scene reconstruction and others. There is an ongoing need to improve the accuracy of this type of machine learning technology whilst having limited memory and computing resources at training time and/or at test time.

Large numbers of training examples are typically used to train the decision forests or DAGs in order to carry out classification tasks such as human body part classification from depth images or gesture recognition from human skeletal data, or regression tasks such as joint position estimation from depth images. The training process is typically time consuming and resource intensive.

There is an ongoing need to improve generalization ability of these types of machine learning systems. Generalization ability is being able to accurately perform the task in question even for examples which are dissimilar to those used during training. There is also a desire to reduce the amount of time, memory and processing resources needed for training machine learning systems such that they are highly accurate. For example, decision trees grow exponentially with depth and so cannot be trained too deeply on computers with limited memory. Even if large amounts of memory are available during training, the resulting decision trees may be too large to fit at test time on limited memory devices such as smartphones or embedded devices. This in turn limits their accuracy.

The embodiments described below are not limited to implementations which solve any or all of the disadvantages of known machine learning systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Non-greedy machine learning for high accuracy is described, for example, where one or more random decision trees are trained for gesture recognition in order to control a computing-based device. In various examples, a random decision tree or directed acyclic graph (DAG) is grown using a greedy process and is then post-processed to recalculate, in a non-greedy process, leaf node parameters and split function parameters of internal nodes of the graph. In various examples the very large number of options to be assessed by the non-greedy process is reduced by using a constrained objective function. In examples the constrained objective function takes into account a binary code denoting decisions at split nodes of the tree or DAG. In examples, resulting trained decision trees are more compact and have improved generalization and accuracy.

A non-greedy process is one which takes into account, or considers, a total number of choices. In contrast a greedy process considers fewer than the total number of choices.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a plurality of different systems in which a machine learning system with random decision trees or DAGs that have been trained using a non-greedy process are used;

FIG. 2 is a schematic diagram of a non-greedy machine learning engine that may be used to produce the trained decision trees of FIG. 1;

FIG. 3 is a schematic diagram of two random decision trees and associated binary codes;

FIG. 4 is a flow diagram of a method which may be implemented at the optimizer of FIG. 2;

FIG. 5 is a flow diagram of another method which may be implemented at the optimizer of FIG. 2;

FIG. 6 is a flow diagram of a method of training random decision trees or DAGs for depth sensing and/or gesture recognition;

FIG. 7 is a flow diagram of a method of using the trained random decision trees or DAGs of FIG. 6 to control a computing device;

FIG. 8 illustrates an exemplary computing-based device in which embodiments of a system for training random decision forests or DAGs may be implemented; in some examples the computing-based device of FIG. 8 is used for depth sensing and/or gesture recognition.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

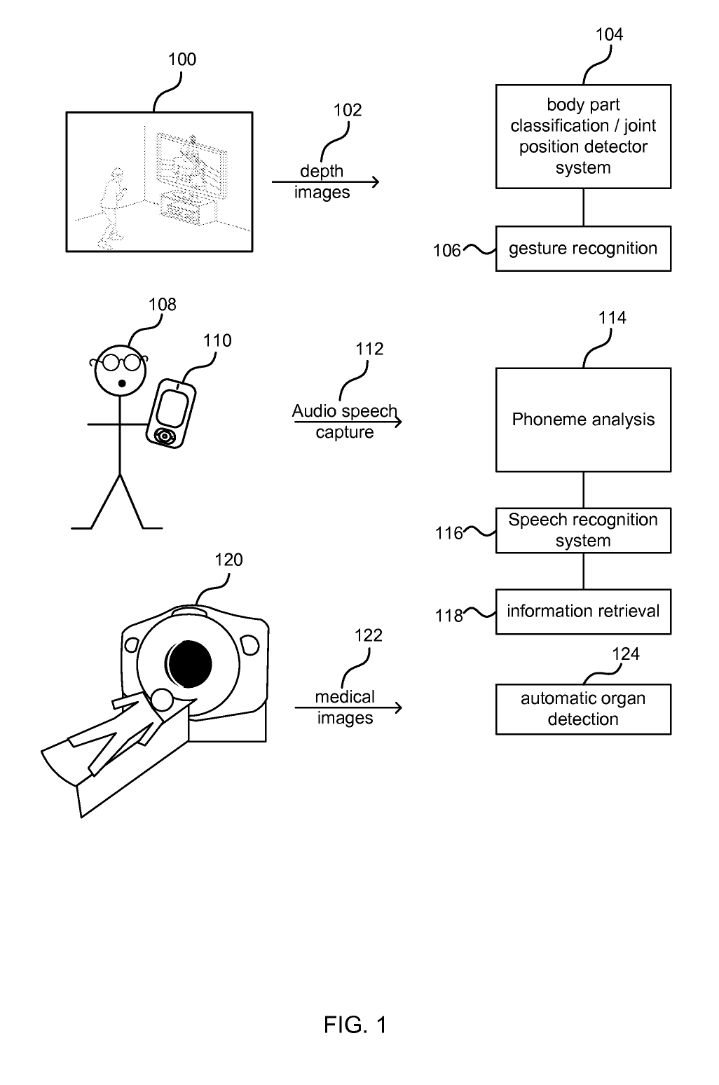

FIG. 1 is a schematic diagram of a plurality of systems in which a machine learning system with non-greedily trained random decision trees or directed acyclic graphs (DAGs) is used. For example, a body part classification or joint position detection system 104 operating on depth images 102. The depth images may be from a natural user interface of a game device as illustrated at 100 or may be from other sources. The body part classification or joint position detection system 104 comprises trained random decision forests or DAGs, where the forests or DAGs have been trained using a non-greedy process as described herein. The body part classification or joint position information may be used to calculate gesture recognition 106.

In another example, a person 108 with a smart phone 110 sends an audio recording of his or her captured speech 112 over a communications network to a machine learning system 114 that carries out phoneme analysis. The phonemes are input to a speech recognition system 116 which uses random decision forests or DAGs that have been trained using a non-greedy process as described herein. The speech recognition results are used for information retrieval 118. The information retrieval results may be returned to the smart phone 110.

In another example medical images 122 from a CT scanner 120, MRI apparatus or other device are used for automatic organ detection 124. The automatic organ detection 124 system comprises random decision forests or DAGs that have been trained using a non-greedy process as described herein.

In the examples of FIG. 1 a machine learning system using random decision trees or DAGs is used for classification or regression. The random decision trees or DAGs have been trained using a non-greedy process that takes into account parameters of internal split nodes, and parameters of leaf nodes, of the random decision trees or DAGs. This gives better accuracy and/or generalization performance as compared with previous systems using equivalent amounts of computing resources and training time. The resulting decision trees are compact which facilitates their use on devices where memory resources are limited such as on smart phones or embedded devices.

More detail about random decision trees and DAGs is now given.

A random decision tree comprises a root node connected to a plurality of leaf nodes via one or more layers of internal split nodes. A random decision tree may be trained to carry out classification, regression or density estimation tasks. For example, to classify examples into a plurality of specified classes, to predict continuous values associated with examples, and to estimate densities of probability distributions from which examples may be generated. During training, examples with associated ground truth labels may be used.

In the case of image processing the examples are image elements of an image. Image elements of an image may be pushed through a trained random decision tree in a process whereby a decision is made at each split node. The decision may be made according to characteristics of the image element and characteristics of test image elements displaced therefrom by spatial offsets specified by parameters at the split node. At a split node the image element proceeds to the next level of the tree down a branch chosen according to the results of the decision. During training, parameter values are learnt for use at the split nodes and data is accumulated at the leaf nodes. For example, distributions of labeled image elements are accumulated at the leaf nodes. Parameters describing the distributions of accumulated leaf node data may be stored and these are referred to as leaf node parameters in this document.

Other types of examples may be used rather than images. For example, phonemes from a speech recognition pre-processing system, or skeletal data produced by a system which estimates skeletal positions of humans or animals from images. In this case test examples are pushed through a trained random decision tree. A decision is made at each split node according to characteristics of the test example and of a split function having parameter values specified at the split node.

The examples may comprise sensor data, such as images, or features calculated from sensor data, such as phonemes or skeletal features. Other types of example may also be used.

An ensemble of random decision trees may be trained and is referred to collectively as a forest. At test time, image elements (or other test examples) are input to the trained forest to find a leaf node of each tree. Data accumulated at those leaf nodes during training may then be accessed and aggregated to give a predicted regression or classification, or density estimation output. By aggregating over an ensemble of random decision trees in this way improved results are obtained.

Previous approaches for training random decision trees have comprised growing a random decision tree one node at a time in a greedy manner according to some splitting criteria such as information gain or Gini index. These previous processes are referred to as greedy because future nodes of the tree, yet to be grown, are not considered when calculating split node parameter values for the node being grown.

A directed acyclic graph is a plurality of nodes connected by edges so that there are no loops and with a direction specified for each edge. An example of a directed acyclic graph is a binary tree where some of the internal nodes are merged together. A more formal definition of a DAG specifies criteria for in-degrees and out-degrees of nodes of the graph. An in-degree is the number of edges entering a node. An out-degree is a number of edges leaving a node. In some of the examples described herein rooted DAGs are used. A rooted DAG has one root node with in-degree 0; a plurality of split nodes with in-degree greater than or equal to 1 and out-degree 2; and a plurality of leaf nodes with in-degree greater than or equal to 1. As a result of this topology a DAG comprises multiple paths from the root to each leaf. In contrast a random decision tree comprises only one path to each leaf. A rooted DAG may be trained and used for tasks, such as classification and regression, in a similar way to a random decision tree.

Some previous approaches to learning rooted DAGs have comprised growing the DAG one layer at a time (rather than one node at a time). Split node parameters and connections between nodes of the new layer with a parent layer are then selected using knowledge of the new layer and one or more previous layers. These approaches are greedy as future layers of the tree, yet to be grown, are not considered when calculating split node parameter values and connection parameter values.

An intrinsic limitation of any greedy tree (or DAG) training algorithm is that when the split functions at the top levels of the tree (or DAG) are being optimized, the algorithm is unaware of the split function to be introduced later at the bottom levels. However, a non-greedy training algorithm would have so many combinations to assess that no practical non-greedy training algorithm has been possible before now. For example, the large number of combinations to be assessed may comprise, for a single training example, combinations of a plurality of potential split node parameter values for each of the plurality of internal nodes of the tree or DAG. As the number of training examples is large the number of combinations to be assessed further increases, making it impractical to compute assessment of the possible combinations and make a best selection. The number of combinations (possible random decision trees/DAGs) to be assessed may be referred to as a search space.

The examples described herein show how practical non-greedy training processes may be implemented. This is achieved by devising an objective function to express an aim of finding split node parameter values and leaf node parameter values for a whole random decision tree (or DAG) which give a best result according to a set of training examples. The objective function may be intractable to solve and so may be replaced by a surrogate function which is similar to the objective function but which can be computed. The surrogate function may limit the number of different combinations that the non-greedy training algorithm is to assess. For example, by placing an upper bound on the objective function. The upper bound may reduce the search space in a manner which still enables good working results to be achieved; that is the accuracy of the resulting trained random decision tree or DAG is good. The upper bound reduces the search space in a manner which is unlikely to remove good solutions from the search space.

In various examples a new representation of a random decision tree or DAG is used in order to compute the upper bound. The new representation comprises a binary code and a tree navigation function. The binary code is a vector having one binary element per split node, the binary elements representing binary test outcomes at split nodes given a training example. The representation also comprises a tree navigation function which may be applied to the vector to compute which leaf/terminal node the training example will reach. The vector is referred to herein as a binary latent decision vector and is denoted by the symbol h. The vector h may have one element per split node, even though there is only one path from a root node to a leaf node of a random decision tree, for a given example. In the case of a DAG there may be more than one path from a root node to a terminal node for a given example. The order of the elements in the vector h may be according to a depth first, left right traversal of the tree or DAG.

In various examples, the upper bound is computed using the new representation as described in more detail below.

The resulting trained random decision trees or DAGs (from the non-greedy training process) are guaranteed to be more accurate in making predictions on the training data than their equivalents trained using a greedy process. This can in turn mean that shallower (non-greedily trained) trees may have the same accuracy as deeper greedily trained trees. This is a significant benefit as the memory requirements for storage and for operation at test time are reduced. This makes it possible to store and/or use the resulting trained machine learning systems on smart phones and other resource constrained, or embedded devices. In addition, the resulting trained machine learning systems have better generalization performance and/or are more accurate than equivalent random decision trees/DAGs trained using a greedy process.

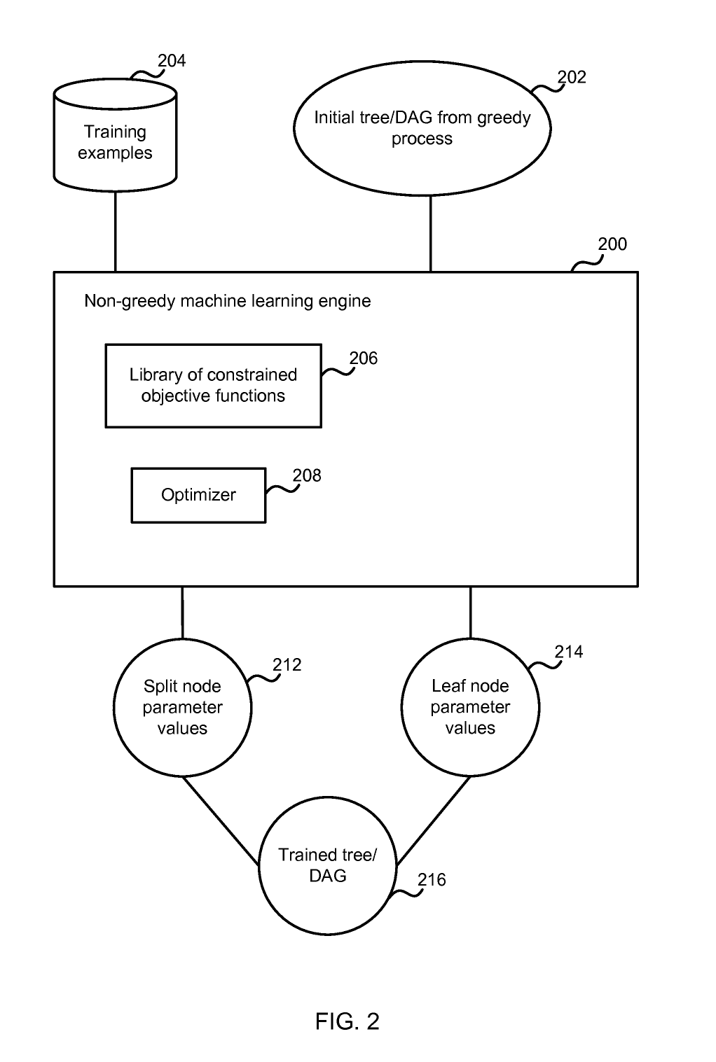

FIG. 2 is a schematic diagram of a non-greedy machine learning engine 200 used to train random decision trees or DAGs. The non-greedy machine learning engine 200 takes as input an initial random decision tree or DAG 202 created using a greedy process. Any suitable greedy process may be used to form the initial random decision tree or DAG. Examples of greedy processes for training a DAG for classification and/or regression tasks are given in U.S. patent application Ser. No. 14/079,394 entitled “Memory facilitation using directed acyclic graphs” filed on 13 Nov. 2013.

The initial random decision tree or DAG 202 comprises a topology, that is, details of the number of nodes of the graph and how they are connected together, as well as initial split node parameter values and leaf node parameter values.

The non-greedy machine learning engine 200 also takes as input a plurality of training examples 204. There may be many thousands or millions of training examples. Each training example comprises an empirical observation or a synthetically generated example, together with ground truth data for the appropriate task. The appropriate task is the task that the resulting trained decision tree or DAG is to carry out. In the case of object recognition, the ground truth data may comprise object class labels for image elements of an image depicting a plurality of objects.

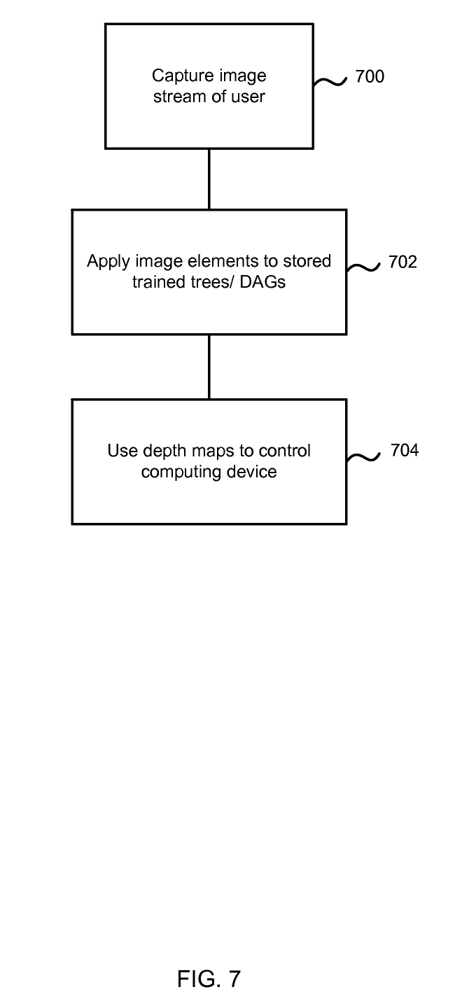

The non-greedy machine learning engine 200 is computer implemented using software and/or hardware. It comprises at least one constrained objective function and optionally, a library 206 storing a plurality of constrained objective functions. More detail about constrained objective functions is given later in this document. The non-greedy machine learning engine 200 also comprises an optimizer 208 for solving the constrained objective functions. Another example of a computer for implementing a non-greedy machine learning engine 200 is described below with reference to FIG. 7.

The non-greedy machine learning engine produces as output, values of split node parameters 212 and leaf node parameters 214 to be used in a new trained decision tree or DAG 216. The new trained decision tree or DAG may be stored and used in place of the initial tree or DAG 202 for carrying out regression, classification or density estimation tasks.

As mentioned above a new representation of a random decision tree (or DAG) is used. This new representation is used in the constrained objective functions stored in the library 206. The new representation associates a binary latent decision variable with each split node. A latent variable is an unobserved variable to be learnt during machine learning. One binary latent decision variable for each split node may be stored in a vector referred to herein as a binary latent decision vector. Each entry in the vector represents a decision made at a split node when that split node is presented with a given example. So for a given example there is a single binary latent decision vector having one entry for each split node, each entry being +1 or −1 to represent whether the decision at the split node will be to send the example to the right (+1) child node or left (−1) child node when the given example is examined at that split node. The new representation also comprises a tree navigation function which determines, for a given example, the leaf node that the example will reach, on the basis of the binary latent decision vector for the example.

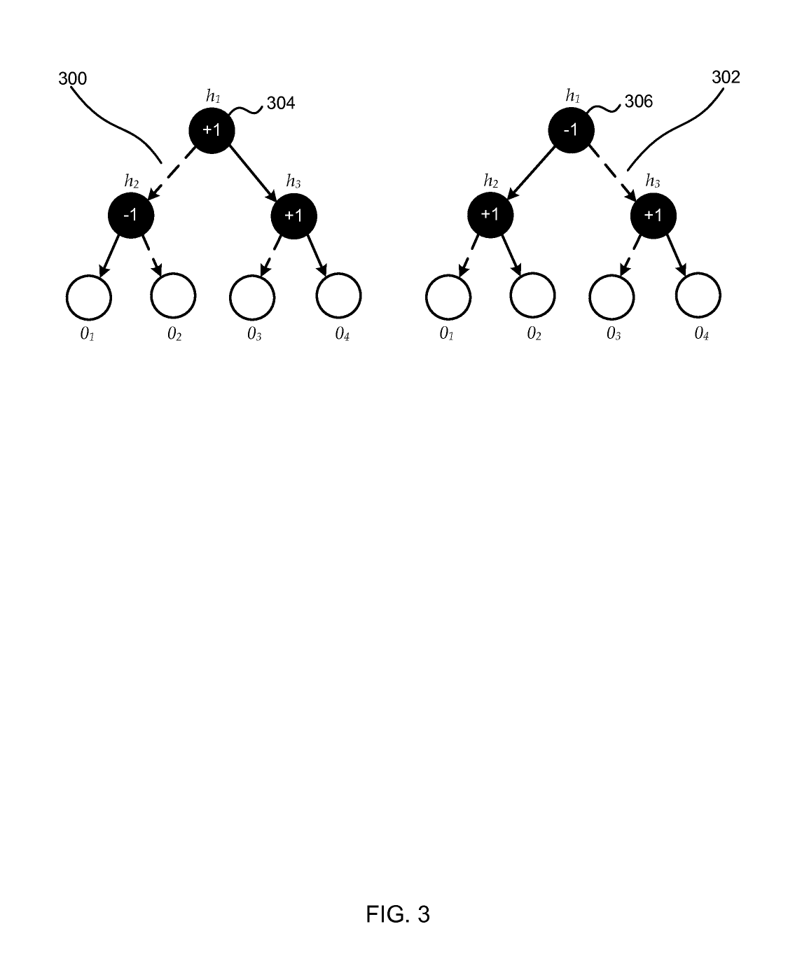

FIG. 3 is a schematic diagram of two random decision trees 300, 302 with latent decision variables h₁, h₂, h₃. A first random decision tree 300 has root node 304 which has assigned to it binary latent decision variable h₁. In this example, h₁ has the value +1 indicating to move to the right child node as indicated by the solid arrow. The right child node has assigned to it binary latent decision variable h₃. In this example, h₃ has the value +1 indicating to move to the leaf node 04 as indicated by the solid arrow. The left child node of the root node has assigned to it binary latent decision variable h₂. In this example h₂ has the value −1 indicating to move to the leaf node 0₁ as shown by a solid arrow.

The new representation may comprise a tree navigation function denoted f(h) where h is the vector of latent binary decision variables of the split nodes. This vector is also referred to herein as a binary code. An example of the tree navigation function, for the first random decision tree of FIG. 3 having root node 304 is:

Tree navigation function f applied to a latent binary decision vector with values for h₁, h₂, h₃ being +1, −1, +1 respectively produces as output an indicator vector indicating that leaf node 0₄ of the first random decision tree of FIG. 3 is reached. However, the tree navigation function f is configured so that when applied to a latent binary decision vector with values for h₁, h₂ and h₃ being +1, +1, +1 respectively (as in the case of tree 302, with root node 206) it produces the same output. This example shows that the value of h₂ does not matter in this situation.

As mentioned above, an objective function is defined to express an aim of searching for split node parameter values and leaf node parameter values of the random decision tree or DAG which best process the training examples according to the particular task. For example, in the case of classification tasks, such as labeling image elements for image segmentation, object recognition and other image labeling tasks, the objective function may be formulated as an expected loss as follows:

L(W,Θ, [symbol] )= [symbol] [symbol] (T(x;W,Θ),y)

Which may be expressed in words as, an expected loss L of a decision tree (or DAG)'s parameters W, Θ, given a set of training examples D is equal to the sum over the pairs of examples and ground truth labels (x,y) in the training set D of the discrepancy between a vector predicted by the decision tree or DAG and the corresponding ground truth label y. The discrepancy is computed by the function [symbol] . The vector predicted by the tree or DAG when given example x is the result of the function T. Define T(x; W, Θ)=Θ^{T}f(h*) where h*= [symbol] m{h^{T}Wx}. That is, for any example x, T(x; W, Θ) predicts the leaf node h* reached in the tree.

As mentioned above, a surrogate objective function is used in place of the objective function. In various examples, the surrogate objective function is:

L′(W,Θ, [symbol] )=Σ_{(x,y)εD}(max_{gεH}_{^{m}}{g^{T}Wx+ [symbol] (Θ^{T}f(g),y)− [symbol] m{h^{T}Wx})

Subject to ∀ᵢ∥wᵢ∥²≦v

Where vε [symbol] ⁺ is a regularizer parameter and wᵢ is the i^{th} row of W. In some examples, hard constrains may be used to enable sparse gradient update of rows of W, when the gradients for most rows of W are zero.

The example surrogate objective function given above may be expressed in words as:

an expected loss L′ of a decision tree (or DAG)'s parameters W, Θ, given a set of training examples [symbol] is equal to the sum over all the pairs of examples and ground truth labels (x,y) in the training set [symbol] of, an upper bound. The upper bound comprises the difference between a first term [symbol] m{g^{T}Wx+ [symbol] (Θ^{T}f(g),y), which involves maximization over g (the vector g is the latent binary decision vector calculated in a more complex manner than the vector h, which is the latent binary decision vector calculated as a standard random decision tree would produce it) and is referred to as loss augmented inference, and a second term [symbol] m{h^{T}Wx} which involves maximization over h. The first term augments the maximization over h with a loss term. The first term may be solved efficiently and exactly as described below. The first term and the second term are both optimization problems. The surrogate loss function may be computed as the difference of the two optimization problems. The first problem optimizes the binary code encoding the path through the tree which maximizes the score and the loss incurred when predicting according to the parameters of the leaf node reached. The second optimization problem maximizes the score of the binary code.

The first term is calculated using g and the second term is calculated using h. The two vectors g and h are both binary codes representing binary decisions made at nodes of a random decision tree or DAG when a specified example reaches the nodes. While computing the binary code g the methods described herein take into account the loss function incurred by predicting the parameters of the leaf nodes reached by adopting the code g, whereas while optimizing the binary code h, this information is not considered.

The optimizer of FIG. 2 may be used to compute a minimization of the surrogate objective function. Any suitable type of optimization may be used. For example, convex concave procedure, simulated annealing, stochastic gradient descent. Convex concave procedure is a method for minimization of objective functions expressed as a sum of a convex and a concave term.

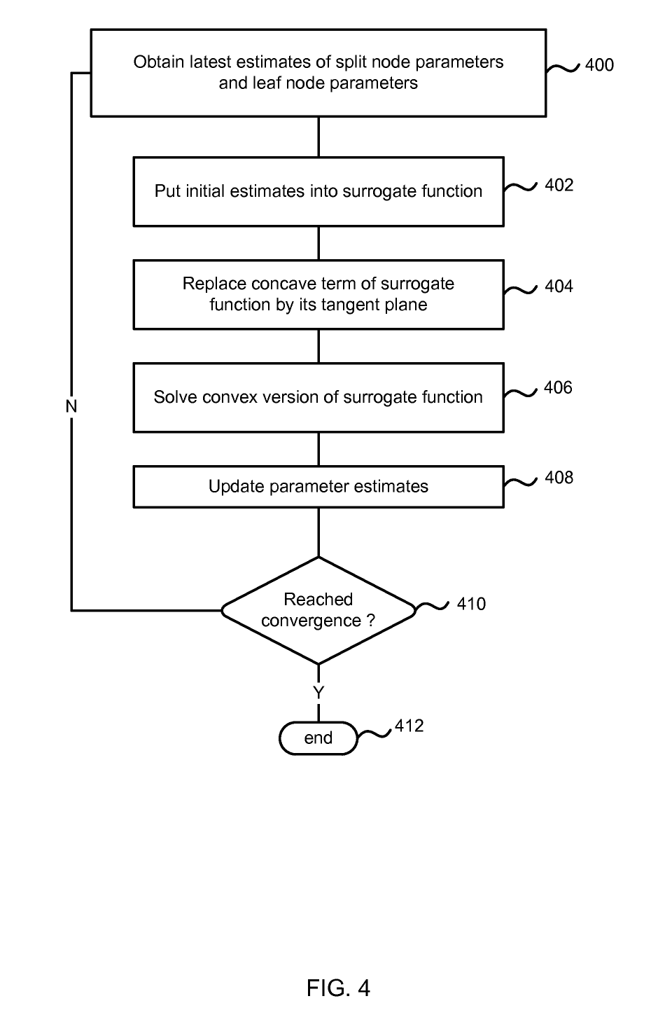

In an example, convex concave procedure (CCCP) may be used to minimize the surrogate objective function as now described with reference to FIG. 4. The latest estimates of the split node parameters and leaf node parameters are accessed 400 and put into the surrogate function 402. For example, at the start of the process these may be initialized to default values. During the process these values are those computed in the last iteration.

At each iteration of CCCP, the concave term in the surrogate objective is replaced 404 by its tangent plane at the current estimate of the parameters, to yield a convex optimization problem which may be solved 406. Let W^{old} denote the W parameters at the end of the previous iteration. Then, at the new iteration, W^{old} and Θ are updated by finding the global optimum of:

argmin_{W,Θ} [symbol] ( [symbol] m{g^{T}Wx+ [symbol] (Θ^{T}f(g),y)}−sgn(W^{old}x)^{T}Wx)

Subject to ∀ᵢ∥wᵢ∥²≦v

The above equation may be expressed in words as: find the minimum, over possible split node parameter values and possible leaf node parameter values of, the sum over all the pairs of examples and ground truth labels (x,y) in the training set D of, the difference between the loss augmented inference term of the surrogate objective and an inner product between the binary code at the previous iteration and the training example x times the split node parameters.

The solution is used to update the parameter estimates at step 408. If convergence is reached 410 the process ends 412; otherwise the iteration continues from step 400.

In an example stochastic subgradient descent is used to optimize the above equation in the inner loop of the CCCP process.

Where stochastic subgradient descent is used, after each subgradient update, W (the split node parameters) is projected back into the feasible set. The CCCP is guaranteed to converge to a local optimum or a saddle point.

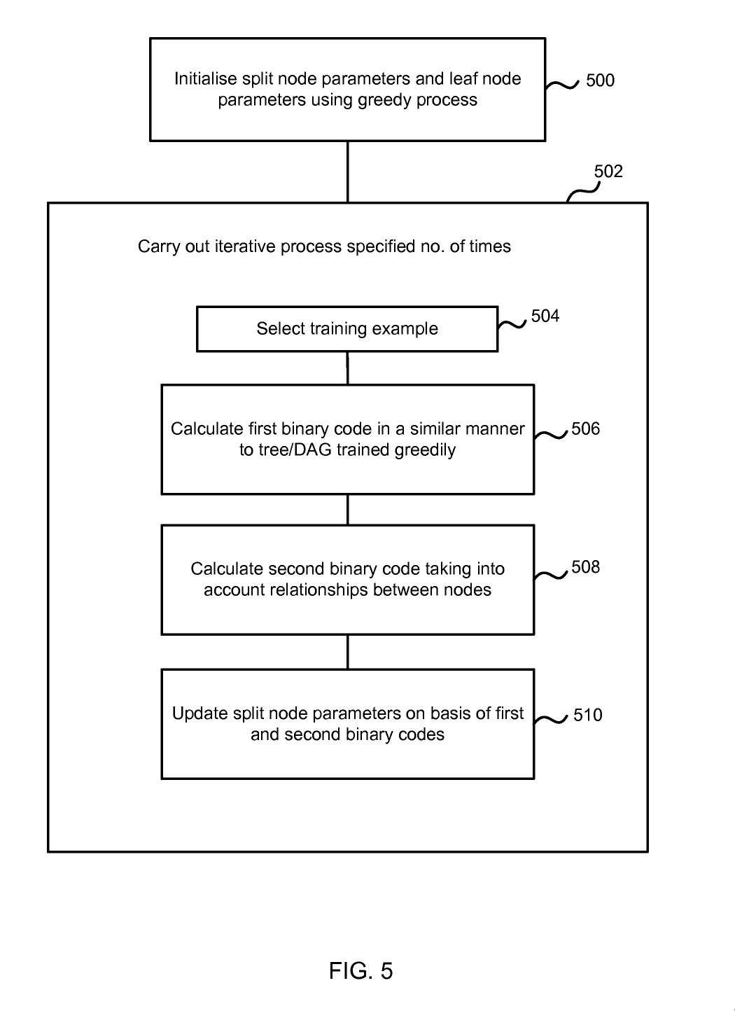

In another example, stochastic gradient descent is used to compute a minimization of the surrogate objective function. This is now described with reference to FIG. 5. It has unexpectedly been found that this method is faster and often more accurate than the CCCP method mentioned above for training random decision trees and DAGs on classification tasks. Having said that, the CCCP method is workable in many situations depending on the application domain and the amount of training data.

An example process for minimizing the surrogate objective function for non-greedy decision tree learning using stochastic gradient descent is now given:

1: Initialize W⁽⁰⁾ and Θ⁽⁰⁾ using greedy procedure

2: For t=0 to τ do

3: Sample a pair (x, y) uniformly at random from D

4: ĥ←sgn(W^{(t)}x)

5: ĝ← [symbol] m{g^{T}W^{(t)}x+ [symbol] (Θ^{T}f(g),y)}

$${W}^{( t + \frac{1}{2} )} ← {W}^{( t )} - η \hat{g} {x}^{T} + η \hat{h} {x}^{T} \qquad 6$$

7: For i=1 to m do

$${W}_{i , .}^{( t + 1 )} ← min \{ 1 , \frac{\sqrt{v}}{{\vert \vert {W}_{i , .}^{( t + \frac{1}{2} )} \vert \vert}_{2}} \} {W}_{i , .}^{( t + \frac{1}{2} )} \qquad 8$$

9: End for

$${Θ}^{( t + 1 )} ← 𝒫 Δ ( {Θ}^{( t )} - η \frac{\partial }{\partial Θ} 𝓁 ( {Θ}^{( t )} f ( \hat{g} , y {\vert}_{Θ = {Θ}^{( t )}} ) . \qquad 10$$

11. End for

Line 1 of the above process comprises setting initial values of the split node parameters and the leaf node parameters using a random decision tree or DAG which has been trained using a greedy process on the particular task concerned (see step 500 of FIG. 5). Line 2 comprises carrying out an iterative process using a for loop which is executed a specified number of times τ (see box 502 of FIG. 5). The specified number of times may be preconfigured depending on the application domain. At each iteration of the for loop a training example x and its ground truth label y is selected (see step 504) from the training set D. The best binary values of a first latent decision vector ĥ are calculated (see step 506) by applying a sign function sgn to the training example x applied to the split node parameters W. The latent decision vector ĥ represents binary decisions at the split nodes, given training example x, which are calculated in a similar manner to a decision tree or DAG which had been trained in a greedy manner. This is because the elements or rows of the vector h are assumed to be independent in the calculation of line 4.

The best binary values of a second latent decision vector ĝ are calculated in line 5 (see box 508). In the calculation of line 5 the elements of rows of the vector g are not assumed to be independent. The calculation of line 5 comprises finding the vector g which maximizes an inner product between the vector g and the training example applied to the split node parameter values, plus a loss term. The loss term expresses a difference between the parameter values of the leaf node indexed by the training example given the split node decisions g, and the labeled ground truth example y. More detail about how the best binary values of the second latent decision vector ĝ may be calculated in an efficient manner are given later in this document.

The process proceeds to update the split node parameters and leaf node parameters on the basis of the first and second binary codes (see box 510 of FIG. 5). For example, this is achieved by executing lines 6, 7 and 8.

Line 6 comprises a gradient update in W (the split node parameters) where the symbol η denotes the learning rate. Line 7 performs projection back to the feasible region of W and line 8 updates the leaf node parameters and projects the leaf node parameters back on the simplex.

In some examples, the method described above is modified by applying momentum and/or mini-batches.

In some examples, line 4 of the above process is changed so that W^{(t)} is replaced with W^{old} of the convex concave procedure described above. In this way, an effective, efficient, process for optimizing the equation of the inner loop of the CCCP process is obtained.

In some examples the stochastic gradient descent process described above is modified to avoid some leaf nodes remaining empty and not having any data points assigned to them. For example, the assignment of data points to leaves is fixed and the bound is optimized with respect to a set of data point leaf assignment constraints. When the improvement in the bound becomes negligible, then the leaf assignment variables are updated, followed by another round of optimization of the bound. This may be referred to as stable stochastic gradient descent because it changes the assignment of data points to leaves more conservatively than stochastic gradient descent. In stable stochastic gradient descent the process maximizes over h to obtain ĥ′ with respect to a constraint that f(ĥ′)=f(sgn(W^{(old)}x)).

More detail about how the best binary values of the second latent decision vector ĝ may be calculated in an efficient manner are now given. This is also referred to as finding the solution to loss augmented inference, which is finding the binary code that maximizes a sum of a score and loss term as follows:

\hat{g}← [symbol] m{g^{T}Wx+ [symbol] (Θ^{T}f(g),y)}

It is recognized herein that f(g) may have m+1 distinct values, which correspond to terminating at one of m+1 leaves of a random decision tree and selecting a distribution from the leaf node parameters at that leaf Note that a random decision tree with m split nodes, has m+1 leaf nodes. It is also recognized herein that it is possible to omit from consideration, those split nodes which are off the path from the root node to a leaf node. That is, a given example takes a single path from a root node to a single leaf node of a random decision tree as mentioned above. The below equation uses a subtraction to remove from consideration those split nodes which are off the path from the root node to leaf node j.

\hat{g}← [symbol] m{g−sgn(Wx))^{T}Wx+ [symbol] (θⱼ,y)}

A depth first search on the decision tree is carried out to calculate g using the above equation for every leaf node and then to choose the best g from those calculated. This algorithm gives good working results where the decision tree is shallow. For deeper decision trees this algorithm may be used where processing time and/or computing resources are not limited.

In another example, the search space is further restricted so as to enable efficient computation even for deeper random decision trees. This example is workable for random decision trees but not for DAGs. For example, the search space (for vector g) is restricted according to characteristics of the binary code, using a Hamming ball. For example, possible binary codes (values of g) are considered which differ by at most one bit from the binary code h computed using sgn(Wx). For example, the surrogate object function may be

L′(W,Θ, [symbol] )= [symbol] (max_{gεB}_{₁}_{(sgnWx)}{g^{T}Wx+ [symbol] (Θ^{T}f(g),y)− [symbol] m{h^{T}Wx})

Where B₁(sgnWx) denotes the Hamming ball around sgn(Wx) with a radius of 1

Examples in which random decision trees and/or DAGs are used for depth sensing and/or gesture recognition are now given. The sensed depth and/or gestures may be used to control a computing device such as a personal computer, mobile phone, laptop, tablet computer or other computing device.

Labeled training images 500 are stored in a database 500. For example, these may be RGB images of a person, or part of a person in a scene, operating a computing device using gestures. The RGB images may be captured by a camera at the computing device. The RGB images may be labeled with empirically observed depth values indicating the depth from the camera to the person in the scene. It is also possible for the labeled training images to be synthetically generated.

The labeled training images are used to greedily train 602 random decision trees or DAGs to compute depth maps from input RGB images. The greedy training process may use an information gain objective as mentioned above.

A post processing stage recomputes 604 the split node parameters and leaf node parameters of the greedily trained trees/DAGs using a non-greedy process as described above. The resulting trained trees/DAGs are stored 606 at the computing device (or at a cloud service in communication with the computing device).

With reference to FIG. 7, during operation of the computing device, the camera captures 700 an image stream of the user as mentioned above. The image stream is not labeled and comprises images not present in the training image database 600. The unlabeled image stream comprises unseen examples; that is, examples which have not previously been available to the computing device during training. Image elements of the images from the stream are applied 702 to the stored trained trees or DAGs to obtain predicted depth values for those image elements, together with uncertainty information about the prediction. Together the predicted depth values of image elements of an image form a depth map. The depth maps 704 are then used to control the computing device. For example, the depth maps are input to a gesture recognition system and the recognized gestures control the computing device. Gesture-based control of games systems, video conferencing systems, graphical user interfaces, medical equipment in clean environments and other gesture based control may be implemented.

Alternatively, or in addition, the functionality of the non-greedy machine learning system described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

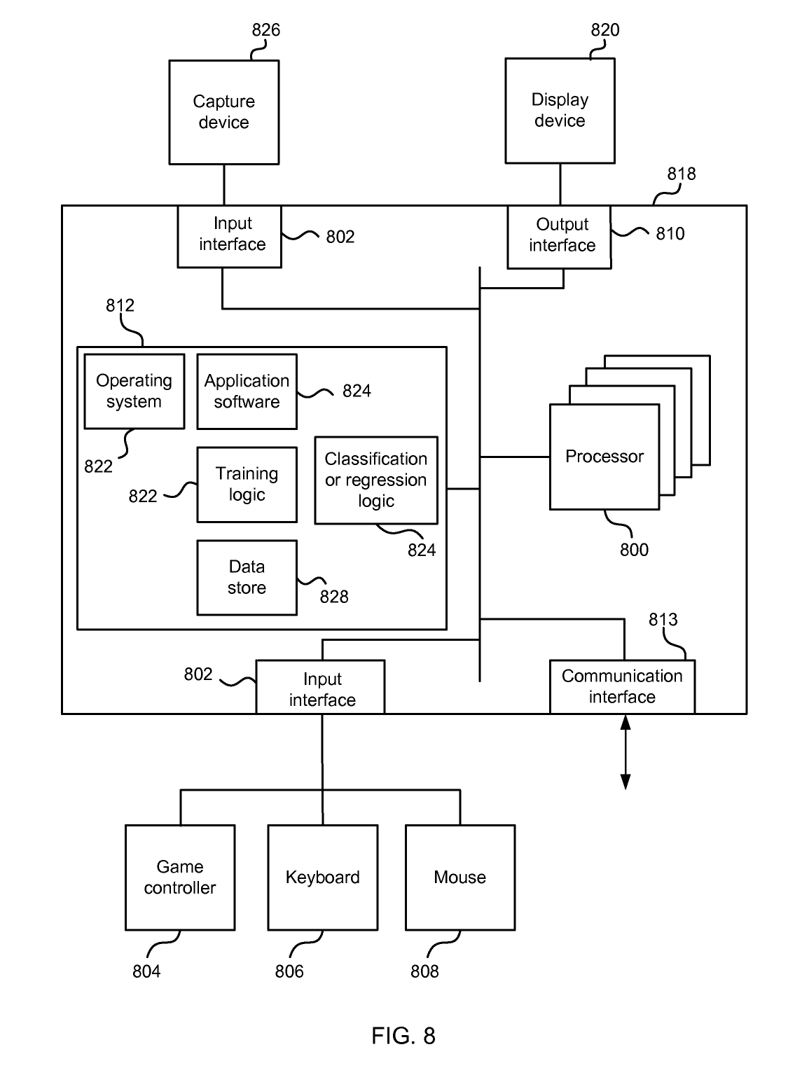

FIG. 8 illustrates various components of an exemplary computing-based device 818 which may be implemented as any form of a computing and/or electronic device, and in which embodiments of a non-greedy machine learning engine; or a control system using non-greedily trained random decision trees or DAGs may be implemented.

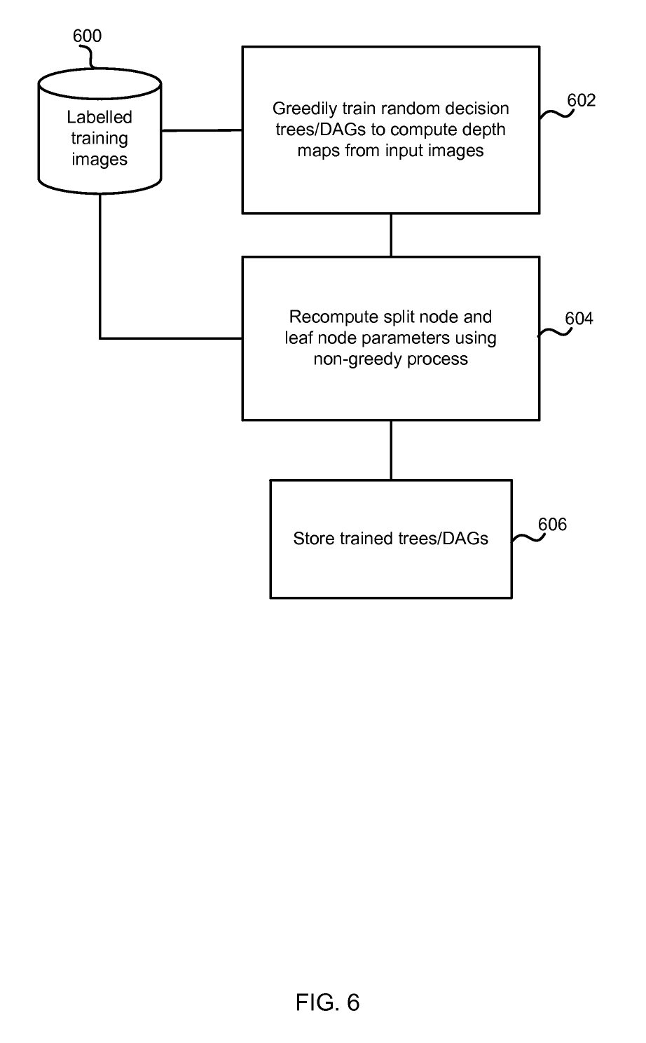

Computing-based device 818 comprises one or more processors 800 which may be microprocessors, controllers or any other suitable type of processors for processing computer executable instructions to control the operation of the device in order to train random decision trees or DAGs in a non-greedy manner; or to operate random decision trees or DAGs which have been trained in a non-greedy manner. In some examples, for example where a system on a chip architecture is used, the processors 800 may include one or more fixed function blocks (also referred to as accelerators) which implement a part of the method of any of FIGS. 4-7 in hardware (rather than software or firmware). Platform software comprising an operating system 822 or any other suitable platform software may be provided at the computing-based device to enable application software 824 to be executed on the device.

The computer executable instructions may be provided using any computer-readable media that is accessible by computing based device 818. Computer-readable media may include, for example, computer storage media such as memory 812 and communications media. Computer storage media, such as memory 812, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 812) is shown within the computing-based device 818 it will be appreciated that the storage may be distributed or located remotely and accessed via a network or other communication link (e.g. using communication interface 813).

In some examples, the computing-based device 818 comprises an input interface 802 which receives input from a capture device 826 such as a video camera, depth camera, stereo camera or other image capture device. For example, this is used where images are to be processed using trained random decision trees or DAGs to recognize gestures or for other tasks.

In some examples, the computing-based device 818 comprises an output interface 810 which sends output to a display device 820. For example, to display a graphical user interface of application software 824 executing on the device.

In some examples the computing-based device 818 comprises input interface 802 which receives input from one or more of a game controller 804, keyboard 806, and mouse 808. For example, where the computing-based device implements a game system with gesture based control, the gestures being recognized from images captured by capture device 826.

The display device 820 may be separate from or integral to the computing-based device 818. The display information may provide a graphical user interface. In an embodiment the display device 820 may also act as a user input device if it is a touch sensitive display device. The output interface 810 may also output data to devices other than the display device 820, e.g. a locally connected printing device.

Any of the input interface 802, output interface 810 and display device 820 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method comprising:
receiving, at a processor, an unseen example;
applying the unseen example to a trained machine learning system, the machine learning system having been trained using training data comprising pairs of training examples and ground truth data, in a non-greedy process, to predict values associated with future examples; a non-greedy process being a process which considers a total number of choices; and
using the predicted values to control a computing device.

2. The method of claim 1 wherein the unseen example, the training examples and the future examples comprise image data or data derived from images.

3. The method of claim 1 wherein the predicted values are class labels and applying the unseen example to the trained machine learning system comprises carrying out classification.

4. The method of claim 1 wherein applying the unseen example to the trained machine learning system comprises carrying out regression.

5. The method of claim 1 comprising receiving a stream of images of a user of the computing device, an image of the stream being the unseen example, and using the predicted values to control the computing device by computing gesture recognition data from the predicted values.

6. The method of claim 1 wherein the trained machine learning system comprises a random decision tree or a directed acyclic graph having been trained using a non-greedy process which calculates parameter values using knowledge of the whole of the random decision tree or directed acyclic graph.

7. A computer-implemented method comprising:
accessing, at a processor, a plurality of training examples comprising pairs of examples and ground truth data;
accessing parameter values of nodes of a graph of connected nodes; and
computing updated values of the parameters using a non-greedy process, being a process that takes the whole graph into account.

8. The method of claim 7 wherein the graph of connected nodes is either a random decision tree or a directed acyclic graph.

9. The method of claim 7 wherein the non-greedy process comprises optimizing a surrogate objective function which is an upper bound on an objective function expressing a loss between values predicted by the graph of connected nodes and the ground truth data.

10. The method of claim 9 comprising computing the surrogate loss as the difference of two optimization problems.

11. The method of claim 10 wherein one of the optimization problems maximizes a score of a binary code.

12. The method of claim 10 wherein the non-greedy process comprises discarding options where the first and second binary codes differ by more than a specified number of bits.

13. The method of claim 7 comprising computing the updated values of the parameters using a non-greedy process that comprises solving an objective function which is constrained by an upper bound.

14. The method of claim 7 comprising searching for values of the parameters which result in a graph which processes the training examples so as to most closely match the ground truth data.

15. The method of claim 7 wherein computing the updated values of the parameters comprises using a stochastic gradient descent optimizer.

16. A computing device comprising:
an input interface arranged to receive an unseen example;
a trained machine learning system, the machine learning system having been trained using training data comprising pairs of training examples and ground truth data, in a non-greedy process, to predict values associated with future examples; a non-greedy process being a process which considers a total number of choices; and
a processor arranged to use the predicted values to control a computing device.

17. The computing device of claim 16 the input interface arranged to receive images from a capture device, the images comprising images of at least part of a user of the computing device.

18. The computing device of claim 16 the trained machine learning system being trained to predict values which are gesture class labels.

19. The computing device of claim 16 wherein the trained machine learning system comprises at least one random decision tree or at least one directed acyclic graph having been trained using a non-greedy process which calculates parameter values using knowledge of the whole of the random decision tree or directed acyclic graph.

20. The computing device of claim 16 the trained machine learning system being at least partially implemented using hardware logic selected from any one or more of: a field-programmable gate array, a program-specific integrated circuit, a program-specific standard product, a system-on-a-chip, a complex programmable logic device, a graphics processing unit.
